(19) United States
(12) Patent Application Publication
(10) Pub. No.: US 2004/0081794 A1
(43) Pub. Date: Apr. 29, 2004

(54) Method for applying adhesive filaments to multiple strands of material and articles formed with the method

(76) Inventor: David M. Titone, Wright City, MO (US)

Correspondence Address: WOOD, HERRON & EVANS, LLP (NORDSON), 2700 CAREW TOWER, 441 VINE STREET, CINCINNATI, OH, 45202, US

(21) Appl. No.: 10/282,593

(22) Filed: Oct. 29, 2002

(51) Int. Cl. B32B 5/12

(52) U.S. Cl. 428/108; 156/167; 156/180

(57) ABSTRACT

A liquid dispensing module dispenses multiple filaments of adhesive material from a single die to coat multiple strands of a substrate material. The liquid filaments are dispensed primarily in an oscillatory or back and forth manner such that each filament coats multiple strands of the substrate material. This results in a coated substrate that exhibits more uniform characteristics across the strands after they are secured to a substrate or substrates.

### FIELD OF THE INVENTION

The present invention generally relates to methods for dispensing multiple filaments of adhesive onto strands of material and, more specifically, to a method of applying adhesive filaments to multiple elastic strands from a single dispensing die or nozzle having multiple dispensing orifices.

### BACKGROUND OF THE INVENTION

Various products require multiple strands of material to be secured to a substrate with adhesive. For example, disposable diapers and incontinence products typically require elasticized areas, such as at the waistband and leg openings to ensure a tight fit with the wearer and prevent leakage. To provide a more comfortable fit to the wearer, manufacturers replaced the thicker rubber band like material previously used at these locations in the past with very thin diameter elastic strands, such as those formed from Lycra®. Creep resistance, which is essentially a measure of the elasticity retained after securing the strands to a substrate with adhesive, was typically not a problem when using the stronger elastic materials of the past. This was because the elastic properties of such materials more readily overcame the effects of the applied adhesive in reducing elasticity. However, the strong elastic properties also caused discomfort to the wearer in the elasticized regions of the product.

As manufacturers of elasticized products moved toward the use of small diameter elastic strands to increase comfort, for example, the problem of creep became more apparent because the effects of the adhesive could more noticeably reduce the elastic properties of the strands after securement to the mating substrate, such as the backsheet of a diaper. For example, many applications used a single nozzle to dispense a filament of adhesive in a spiral pattern which spanned the width of several elastic strands. In some instances, too much adhesive may be applied to outer strands and too little may be applied to the inner strands. This may lead to non-uniform creep resistance characteristics across the width of the secured strands. To enable the use of even less adhesive, multi-orifice meltblown dies have also been used to dispense one adhesive filament onto each of several parallel elastic strands or multiple filaments randomly onto multiple parallel strands. The former method has been used to dispense less adhesive than past methods while achieving successful bonding and increased creep resistance in the resulting product.

One drawback discovered with the present multi-orifice dispensing method in which each of several parallel strands receives a single adhesive filament is that characteristics of the adhesive filaments may vary across the width of the die. For example, certain orifices in the die may dispense more adhesive than other orifices due to various reasons, such as a nonuniform pressure distribution or flow rate across the width of the die. In some current situations, the centrally located elastic strand or strands will receive more adhesive than the outer strands and, thus, the central strand(s) will have less creep resistance. In general, it would be desirable to increase the uniformity of the physical strand characteristics after the adhesive has been applied and the strands have been secured to the substrate or substrates.

Thus, there is a continuing need for methods of applying multiple filaments of adhesive to multiple strands simultaneously while retaining robust and uniform physical characteristics with respect to all strands, such as more uniform creep resistance across an arrangement of parallel elastic strands secured to a substrate.

### SUMMARY OF THE INVENTION

The present invention generally provides a method of applying adhesive filaments to multiple strands using an adhesive applicator having a discharge portion with a plurality of adhesive discharge orifices. The method involves dispensing an adhesive filament from each of the plurality of adhesive discharge orifices toward the multiple strands which are moving in a machine direction. Each adhesive filament is moved primarily back and forth in a direction transverse to the machine direction, and each adhesive filament is applied to at least two of the strands. Since each filament is distributed across at least two individual strands, any variation in the amount of adhesive dispensed from each orifice is distributed more uniformly across the strand grouping, as opposed to being concentrated on only a single strand. For example, if more adhesive is dispensed from the centrally located orifice of the discharge portion, then that adhesive will not be concentrated on the centrally located strand, but will be distributed across one or more additional strands. As a result, the physical characteristics of the product produced with the strands, such as the elasticity of a substrate which is subsequently adhered to the strands, will be more uniform across the width of the elasticized area.

The back and forth movement of the adhesive filaments relative to the strands may take the form of various regular and irregular patterns, such as swirled patterns, generally sinusoidal patterns or omega-shaped patterns. Preferably, the number of adhesive discharge orifices is equal to the number of strands, however, it will be appreciated that a larger or smaller number of orifices may be used as well depending on the application needs.

When forming elasticized portions of products, such as diapers and incontinence products, the strands are preferably elastic and are stretched either prior to or after the application of the adhesive filaments but before securement to the flat substrate. In the preferred embodiment, the elastic strands are moved in the machine direction in a stretched condition for receipt of the adhesive filaments just prior to mating and securement of the strands to one or more flat substrates, such as a nonwoven material or a film material. The invention further contemplates the manufacture of articles comprising one or more flat substrates having an elasticized section formed in accordance with the principles of the invention as generally discussed above. Such articles may take on any forms including, but not limited to, hygienic articles such as diapers and other fluid absorbent or non-absorbent garments.

These and other features and objectives of the present invention will become more readily apparent from the following detailed description taken in conjunction with the accompanying drawings.

### BRIEF DESCRIPTION OF THE DRAWINGS

The accompanying drawings, which are incorporated in and constitute a part of this specification, illustrate embodiments of the invention and, together with a general description of the invention given above, and the detailed description given below, serve to explain the invention.

FIG. 1 is a perspective view of a liquid dispensing module depicting multiple filaments of liquid material being dispensed according to the present invention;

FIG. 2 is a bottom view of a die tip assembly of the liquid dispensing module of FIG. 1; and

FIG. 3 is a schematic perspective view illustrating the inventive principles used to construct an article having an elasticized area.

### DETAILED DESCRIPTION

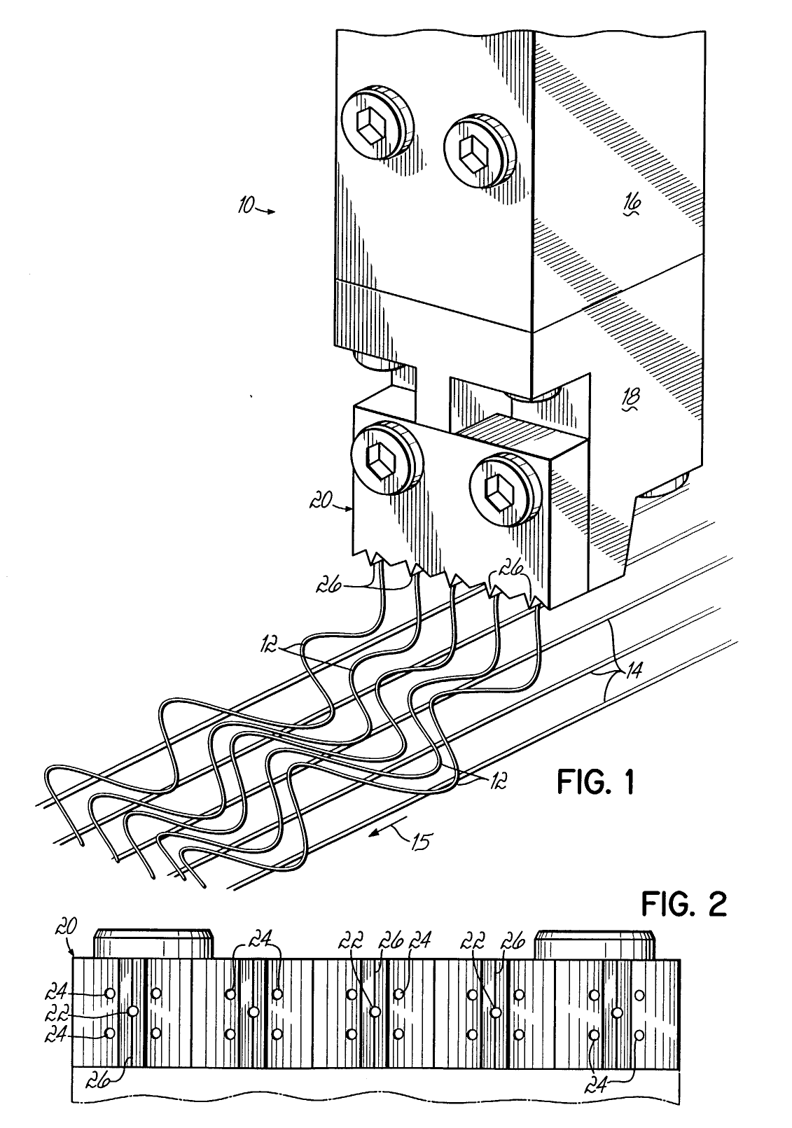

Referring to FIG. 1, a liquid dispensing module 10 is configured to dispense multiple filaments 12 of adhesive to multiple strands 14 of elastic material spaced from module 10 and moving beneath module 10 in a machine direction as indicated by arrow 15. Module 10 is preferably of an on/off type operated by a valve mechanism (not shown) and comprises a central body portion 16, a lower body portion 18, and a discharge portion in the preferred form of a die tip 20. Module 10 selectively dispenses liquid material, such as hot melt adhesive or other viscous liquid typically formed from polymeric material, as described more fully in U.S. Pat. No. 6,435,425, commonly assigned to the assignee of the present invention and herein incorporated by reference in its entirety.

FIG. 2 is a bottom view of die tip 20. The die tip 20 includes a plurality of liquid discharge orifices 22 for dispensing the individual adhesive filaments 12. Each liquid discharge orifice 22 is surrounded by several air discharge passages 24. As filaments 12 are dispensed from the liquid discharge orifices 22, jets of air from respective air discharge passages 24 are directed toward the dispensed filaments 12 to attenuate and direct the flow of the filaments 12, as more fully described in U.S. Pat. No. 6,435,425. As illustrated in FIGS. 1 and 2, die tip 20 may include a wedge-shaped member 26 associated with each liquid discharge orifice 22 and its respective air discharge passages 24 to facilitate directing the jets of air from the air discharge passages 24 to contact the filament 12 in a substantially tangential manner, as opposed to directly impacting the liquid filament 12.

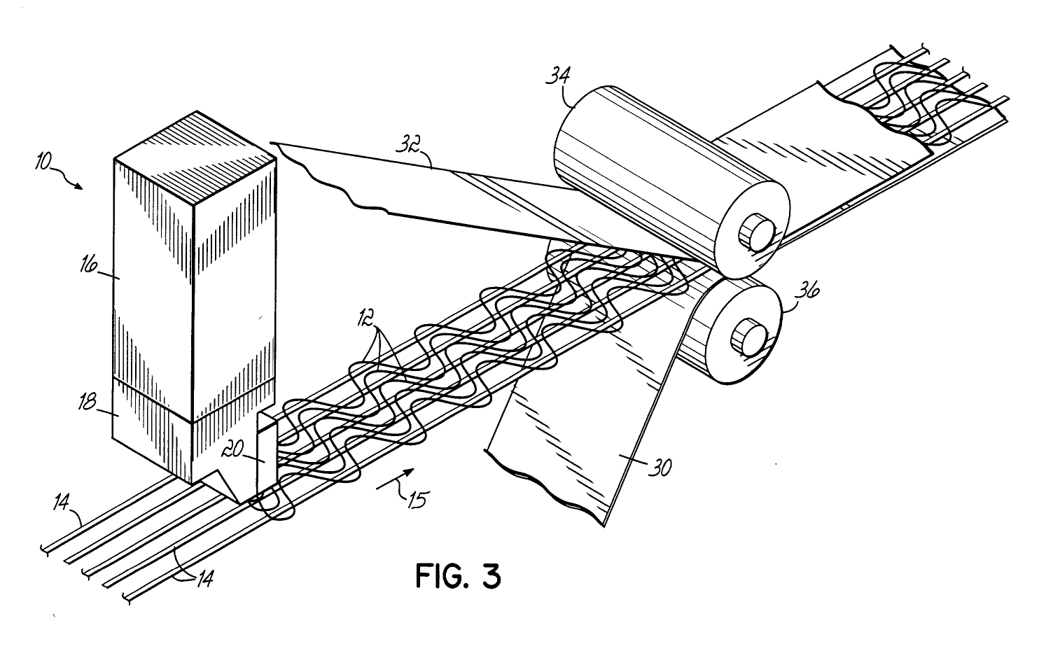

According to the principles of the present invention, the liquid dispensing module 10, and more particularly, the die tip 20, is configured to dispense the filaments 12 onto the multiple strands 14 in an oscillatory or primarily back and forth transverse movement relative to the machine direction 15. Preferably, portions of each filament 12 contact multiple strands 14, as opposed to coating each individual strand 14 with a single liquid filament 12. Alternatively, certain strands 14 may receive an entire filament 12, while other strands 14 may receive only a portion of a filament 12. Applied in this fashion, the liquid material can be more uniformly distributed across the multiple strands 14 in certain situations, thereby minimizing or eliminating the effects of variation in volume or material properties of the dispensed liquid filaments 12 across the die tip 20. Accordingly, the resulting coated strands 14 exhibit more robust and uniform physical characteristics as a group once they are adhered to a substrate or substrates 30, 32 (FIG. 3).

In another aspect of the present invention, the oscillatory or back and forth pattern of the dispensed filaments 12 produced by die tip 20 may be varied to coat multiple strands 14 by adjusting the spacing between strands 14 and die tip 20 and/or spacing between individual liquid discharge orifices 22 on the die tip assembly 20. For example, increasing the spacing between die tip 20 and strands 14 will generally increase the number of strands 14 interlocked by an adhesive filament 12 since the amplitude of the back and forth or oscillatory movement increases with distance from die tip 20.

FIG. 3 is a schematic perspective view of dispensing module being used to apply multiple filaments 12 of adhesive to a plurality of strands 14 just prior to adhering strands 14 to respective flat substrates 30, 32. Substrates 30, 32 are then directed between a pair of rollers 34, 36 to facilitate securement of the two substrates 30, 32 with the strands 14 and adhesive filaments 12 located therebetween. Strands 14 are preferably elastic and in a stretched condition when adhesive filaments 12 are applied and when strands 14 are secured to flat substrates 30, 32. After securement, the bonded substrates 30, 32 are allowed to relax thereby forming an elasticized construction which may, for example, be one of several regions in a disposable hygienic article such as a diaper or adult incontinence product.

More specifically referring to the method illustrated in FIG. 3, a plurality of adhesive filaments 12 are dispensed from a corresponding plurality of adhesive discharge orifices 22 (FIG. 2). The elastic strands 14 are moved in a machine direction 15 and the adhesive filaments 12 move primarily back and forth in a direction transverse to the machine direction 15. The adhesive filaments 12 are applied to the stretched elastic strands 14 with each adhesive filament 12 preferably being applied to at least two of the elastic strands 14. The flat substrates 30, 32 also move in a machine direction 15 and in a converging manner relative to the elastic strands 14 until the flat substrates 30, 32 and the elastic strands 14 are adhered together using the applied adhesive filaments 12. It should be appreciated that strands 14 may be applied to only a single substrate, or to multiple substrates, or to folded over portions of the same substrate. The back and forth movement of the adhesive filaments 12 relative to the machine direction 15 may be, for example, swirling movements, generally sinusoidal movements, zig zag movements or other back and forth patterns in which the movement is primarily transverse to the machine direction 15.

While the method of coating multiple strands of material has been described with respect to moving multiple filaments of liquid material back and forth after they are dispensed from a stationary module, it will be understood by those of ordinary skill in the art that the module 10 or a portion thereof may be moved back and forth to dispense the liquid filaments 12 across multiple strands 14 in manners similar to that described above.

While the present invention has been illustrated by the description of the various embodiments thereof, and while the embodiments have been described in considerable detail, it is not intended to restrict or in any way limit the scope of the appended claims to such detail. Additional advantages and modifications will readily appear to those skilled in the art. The invention in its broader aspects is therefore not limited to the specific details, representative apparatus and methods and illustrative examples shown and described. Accordingly, departures may be made from such details without departing from the scope or spirit of Applicant's general inventive concept.

What is claimed is:

1. A method of applying adhesive filaments to multiple strands using an adhesive applicator having a discharge portion with a plurality of adhesive discharge orifices, the method comprising:
dispensing an adhesive filament from each of the plurality of adhesive discharge orifices;
moving the strands in a machine direction relative to the discharge portion;
moving each adhesive filament primarily back and forth in a direction transverse to the machine direction; and
applying each adhesive filament to at least two of the strands.

2. The method of claim 1, wherein moving each adhesive filament primarily back and forth further comprises swirling each adhesive filament.

3. The method of claim 1, wherein moving each adhesive filament primarily back and forth further comprises moving each adhesive filament in a generally sinusoidal manner.

4. The method of claim 1, wherein the number of adhesive discharge orifices is equal to the number of strands.

5. The method of claim 1, wherein the strands are elastic.

6. The method of claim 5, further comprising:
stretching the elastic strands; and
applying the adhesive filaments to the stretched elastic strands.

7. A method of forming an elasticized section of a flat substrate by securing multiple elastic strands to the flat substrate using an adhesive applicator having a discharge portion with a plurality of adhesive discharge orifices, the method comprising:
dispensing an adhesive filament from each of the plurality of adhesive discharge orifices;
moving the elastic strands in a machine direction relative to the discharge portion;
moving each adhesive filament primarily back and forth in a direction transverse to the machine direction;
stretching the elastic strands;
applying each adhesive filament to at least two of the elastic strands;
moving the flat substrate in the machine direction and in a converging manner relative to the elastic strands; and
adhesively securing the stretched elastic strands to the flat substrate with the applied adhesive filaments.

8. The method of claim 7, wherein moving each adhesive filament primarily back and forth further comprises swirling each adhesive filament.

9. The method of claim 7, wherein moving each adhesive filament primarily back and forth further comprises moving each adhesive filament in a generally sinusoidal manner.

10. The method of claim 7, wherein the number of adhesive discharge orifices is equal to the number of strands.

11. An article comprising:
a first flat substrate having a surface,
a plurality of strands on said surface, and
a plurality of adhesive filaments securing said strands to said surface, said adhesive filaments each extending in a back and forth pattern transversely across at least two of said strands.

12. The article of claim 11, wherein said strands are elastic.

13. The article of claim 12, wherein said strands are parallel to each other.

14. The article of claim 13, further comprising a second flat substrate, said strands being sandwiched between said first and second flat substrates.
